(19) United States
(12) Patent Application Publication
(10) Pub. No.: US 2013/0150231 A1
(43) Pub. Date: Jun. 13, 2013

(54) METHOD OF MANUFACTURING ORDERED INTERMETALLIC CATALYSTS

(71) Applicant: Imra America, Inc., Ann Arbor, MI (US)

(72) Inventors: Kevin V. HAGEDORN, Ann Arbor, MI (US); Bing LIU, Ann Arbor, MI (US); Yong CHE, Ann Arbor, MI (US)

(73) Assignee: IMRA AMERICA, INC., ANN ARBOR, MI (US)

(21) Appl. No.: 13/692,410

(22) Filed: Dec. 3, 2012

Related U.S. Application Data
(60) Provisional application No. 61/567,967, filed on Dec. 7, 2011.

(51) Int. Cl. B01J 37/34; B01J 23/62

(52) U.S. Cl. CPC B01J 37/349; B01J 23/628; Y10S 977/889; Y10S 977/81; Y10S 977/773; B82Y 40/00
USPC 502/5; 502/300; 502/172; 977/889; 977/810; 977/773

(57) ABSTRACT

At least one embodiment includes a method for fabricating a catalyst comprising a colloidal suspension of nanoparticles, the nanoparticles comprising intermetallics of two or more metals exhibiting long range superlattice crystal ordering. The method comprising the steps of: producing a bulk target of the intermetallics of two or more metals exhibiting long range crystal ordering and submerging the target in a solvent. A pulsed laser is used to ablate bulk target material and to produce nanoparticle of the intermetallics of two or more metals exhibiting long range crystal ordering. At least one embodiment includes a catalyst made with the method. The catalyst can exhibit some desirable properties. For example, the catalyst may remain suspended in solution, essentially without surface modification by ionic compounds. Furthermore, the concentration of elements other than those which comprise the solvent or the intermetallic compound may be less than about 1 ppm.

### TECHNICAL FIELD

The present invention relates to the production of chemical catalysts produced by physical methods such as laser ablation in liquid.

### BACKGROUND

The references cited in the endnotes at the end of the specification and referenced below generally relate to ordered intermetallics in catalysis, preparation of ordered intermetallic nanoparticles, and the application of pulsed laser ablation in liquid to the preparation of monometallic and bimetallic nanoparticles.

Ordered intermetallic crystals have unique catalytic properties which could be useful for applications in fuel cells and chemical synthesis. For example, intermetallic crystals of PtPb have demonstrated over an order of magnitude higher specific activity, reduced poisoning, and decreased overpotential as compared to PtRu for the oxidation of methanol and formic acid.¹ Ordered intermetallics can demonstrate high activities for specific multi-step reactions because they combine two different catalytic metals which are each active for a different step of the reaction mechanism. For methanol oxidation on a Pt surface, dehydrogenation of methanol occurs quickly, but the carbon monoxide core remains strongly bonded to the Pt surface and the catalyst loses activity as active sites become occupied.² In the PtPb intermetallic, Pt dehydrogenates the methanol, while Pb acts as an oxygen source by binding hydroxide in solution and completing oxidation of carbon monoxide to carbon dioxide.^{1, 3-4} Commercial direct methanol fuel cells use PtRu,^{2, 5-6} which is a bimetallic alloy where Ru, rather than Pb, acts as the oxygen source. However, for the methanol oxidation reaction, PtPb exhibits reduced poisoning and improved specific activity as compared to PtRu, which is attributed to the difference in crystal structure between these two materials.³⁻⁴ PtRu forms an FCC crystal (Fm 3̅m space group) with Pt and Ru atoms randomly distributed in the FCC lattice. PtPb adopts a hexagonal crystal structure (P6₃/mmc space group, ICSD PDF file no. 06-0374) where Pt and Pb have defined positions within the lattice. On the PtRu surface, the activity of an individual Pt atom varies depending on the number of neighboring Ru atoms. As a consequence, there is a measurable poisoning of the PtRu surface due to Pt atoms which have no neighboring Ru atoms. On the PtPb surface, each Pt atom has identical activity. In addition to PtPb, a number of other ordered intermetallic systems such as Pt₃Ti⁷⁻⁸, PtNi,⁹ PtBi,¹⁰⁻¹⁴ PtHg,¹⁵ PtCd,¹⁵ and PtZn¹⁶ have been discovered which all show promise as methanol oxidation catalysts. In addition, ordered intermetallics are also currently being investigated for applications in glucose sensing¹⁷ and chemical synthesis¹⁸⁻¹⁹ because of their unique catalytic properties.

Although ordered intermetallics show promise for many chemical catalysis applications, there has been no commercial use of these materials because it is difficult to prepare these materials in appropriate morphologies using standard techniques. The paramount concern for applications using rare metals is materials utilization. In chemical catalysis, this means preparing the material in a high-surface-to-volume ratio morphology, such as nanoparticles. Since PtPb was identified as a useful material for methanol oxidation, a number of attempts have been made to create nanoparticles of PtPb using chemical methods.^{10, 12-13, 20-24} However, all of the attempts to make PtPb nanoparticles by chemical reduction of metal salts have encountered similar problems. For one, Pt and Pb have very different electrochemical potentials, so solvents and metal salts need to be carefully chosen so that Pt and Pb “co-reduce” and make single crystals. This limits possible solvent systems to organics like methanol^{12, 20, 23}, diglyme²⁵, and THF.²⁵ Also, chemical reduction of metal salts produces nanoparticles in a medium with a high electrolyte concentration leading to aggregation of the nanoparticles and loss of surface area.²⁶⁻²⁷ Finally, the salts and chelating agents used for synthesis can be problematic after the particles are formed because they can bind particles and occupy active sites on the catalyst.

Pulsed laser ablation in liquid (PLAL) is a method for producing nanoparticles which has seen few commercial applications, but PLAL has several unique features which could be useful for producing nanoparticle catalysts. In PLAL, solid targets are irradiated by a pulsed laser, which produces a plasma that cools when it contacts the liquid and creates nanoparticles. Some notable advantages of using PLAL are the ability to produce stable nanoparticles in any polar solvent without the need for ligands or chelating agents.²⁸⁻²⁹ In addition, it is known that laser ablation using femtosecond pulses limits heating of the target since the excitation pulses are shorter than the thermal relaxation time in the metal.³⁰⁻³³ Such limited heating is a factor to consider when producing PtPb particles because PtPb will oxidize into Pt and PbO at temperatures exceeding 500 C.°.¹¹ Moreover, in PLAL, nanoparticles form from condensation of a highly energetic, high temperature, high pressure plasma which is far from an equilibrium condition.³⁴⁻³⁶ For this reason, monometallic³⁷⁻⁴⁰ and bimetallic⁴¹⁻⁴⁴ metals are relatively simple to produce, whereas single crystal semiconductors will only form under limited conditions.⁴⁵⁻⁴⁸ In addition, PLAL generally produces a large polydispersity of particles. This is because small particles form from the condensation of the plasma, while large particles form when part of the melted target detaches from the surface by various hydrodynamic mechanisms.⁴⁹⁻⁵⁰ Finally, PLAL generally suffers from a high capital equipment cost and low nanoparticle production rate. In order to make this technique relevant for mass production of nanoparticles, the formation of large particles needs to be limited and the particle production rate needs to be increased.

### SUMMARY OF THE INVENTION

In one aspect, the invention includes a method for fabricating a catalyst comprising a colloidal suspension of nanoparticles. The nanoparticles include intermetallics of two or more metals exhibiting long range superlattice crystal ordering, which are also known as ordered intermetallics. The method includes the steps of producing a bulk target of the ordered intermetallic, then submerging the target in a solvent, and using a pulsed laser to ablate bulk target material and produce nanoparticles of the ordered intermetallics.

The particles produced are ordered intermetallics which are compounds of metals which have crystal structures different from their constituent metals. In particular, the Pt—Pt spacing in ordered intermetallics containing platinum is significantly larger than in alloys of platinum or pure platinum metal. The Pt—Pt spacing in PtPb is on the order of 3.0 A, and generally may exceed 2.7 A. Other intermetallics such as PtPb, PtBi, PtBi2, PtSn, Pt3Sn, PdMo, PtNi, or PdGa can be produced with this method and exhibit similar properties to PtPb including a Pt—Pt spacing (or Pd—Pd spacing) longer than in elemental Pt (or Pd). Some of these materials have Pt—Pt (or Pd—Pd) spacings longer than 3.5 A. This is in contrast to alloys, such as PtRu, which utilize the same crystal structure as one of the pure constituent metals (FCC in the case of PtRu), and does not exhibit a longer Pt—Pt spacing.

In at least one embodiment, laser ablation in liquid is used to produce nanoparticles of the ordered intermetallic in a polar solvent. Unlike production of alloy nanoparticles, pulse durations which are less than about 50 ps prevent heating of the intermetallics (which results in phase separation), and pulse durations which are less than 1 ps, for example in the range from about 10 fs-1 ps, are generally preferred. In addition, it was discovered that laser fluences in the range of about 0.01 J cm⁻² to about 0.6 J cm⁻² are preferred. Without subscribing to any particular theory, it is believed that lower fluences than this will lead to Pb being ablated out of the PtPb target leaving a Pt rich target and PbO nanoparticles. Conversely, higher fluences excessively heat the nanoparticles causing them to oxidize to Pt and PbO. The minimum fluence required for production of PtPb nanoparticles is about 0.003 J cm⁻² (i.e. 3 mJ cm⁻²). Fluences of at least about 0.01 J cm⁻² are preferred.

For the liquid, by way of example, ethanol, water, and acetone are preferred because of their safety and low cost. However, nanoparticles can be produced using this method in any suitable polar solvent. In various experiments water was the solvent system of choice for its low cost and safety. In some instances, ethanol was preferred for its superior transmissibility in the UV. Finally, acetone was also used because it is an aprotic solvent, which helps protect the particles from oxidation.

The colloidal suspension prepared by the above method is stable because the nanoparticles are ionized during the ablation process. The zeta-potential of the particles is on the order of −50 eV and the particles in solution have a much longer shelf life than particles prepared by chemical methods. In general, particles prepared by this method will remain suspended in solution for longer than 1 month. In addition, the particles can be prepared directly in water or any other solvent without contamination with other chemical additives. For example, for ordered intermetallic nanoparticles prepared in water, elements other than hydrogen, oxygen, Pt, and Pb are present at concentrations lower than 1 ppm, and can be lower than 100 ppm if industrial grade water, rather than 18 MS2 cm⁻¹ water is used. The particles themselves are generally smaller than 25 nm and can be made smaller than 10 nm if conditions are finely tuned. As demonstrated in FIG. 5, particles smaller than 5 nm can also be produced with this method.

Intermetallic nanoparticles and catalysts made therefrom may be used for fabrication of electrochemical devices and energy conversion devices. The stable colloidal suspension produced in either ethanol or water could be deposited using electrophoretic deposition from a mixture of ethanol/acetone or water/acetone. Physical attachment of the particles to glassy carbon or carbon nanotubes could be accomplished using a mixture of water, isopropanol, and nafion; or ethanol, isopropanol, and nafion. Alternatively, the catalyst may be used as a homogenous catalyst in reactions such as ammonia synthesis or hydrogenation reactions.

### BRIEF DESCRIPTION OF THE DRAWINGS

FIG. 1 is a block diagram schematically illustrating the steps involved in preparing an ordered intermetallic catalyst according to one embodiment.

FIG. 2 schematically illustrates several components of a system for pulsed laser ablation of a target in liquid (PLAL).

FIG. 3 is a transmission electron micrograph of PtPb nanoparticles prepared by pulsed laser ablation in water. (Scale bar: 20 nm.)

FIG. 4 is a high resolution transmission electron micrograph of a PtPb nanoparticle prepared by pulsed laser ablation in water. The d spacing was measured as 2.9 Å. (Scale bar: 5 nm.)

FIG. 5 is a high resolution transmission electron micrograph of particles prepared by nanosecond laser ablation. (Scale bar: 500 nm.)

FIG. 6 illustrates a powder X-ray diffraction pattern of a thin layer of PtPb nanoparticles deposited on a silicon <100> substrate.

FIGS. 7A-7C illustrate energy dispersive x-ray spectroscopy results obtained for particles 301-a, 301-b, and 301-c of FIG. 3.

FIGS. 8A-8B illustrate energy dispersive x-ray spectroscopy results obtained for particles 501-a and 501-b of FIG. 5.

FIGS. 9A-9B schematically illustrate a fuel cell (FIG. 9A) that includes a catalyst according to an embodiment of the present invention, and an expanded schematic view (FIG. 9B) of the catalyst wherein nanoparticles are deposited on nanotubes of an electroactive support.

### DETAILED DESCRIPTION

As used herein, “nanoparticles” refers to particles having a size in the range from about 1 nanometer (nm) to 0.5 micrometers (μm) in at least one dimension.

As used herein, “colloidal suspension” refers to a liquid system wherein surface-charged particles are microscopically suspended due to Brownian motion and electrostatic repulsion between the particles.

As used herein, “electroactive support” refers to any suitable high surface area, or high aspect ratio, material which is electrically conductive.

As used herein, a “stable suspension” refers to a colloidal suspension having nanoparticles that do not aggregate during an extended time period after production, and such stability may be determined by UV-Vis measurements. Aggregation may be observed as a decrease in the intensity of scattering or a decrease in surface plasmon absorption.

As used herein, “ordered intermetallic” refers to compounds of metals which exhibit long range crystal structures. In addition, the crystal structure of the ordered intermetallic differs from the crystal structure of the constituent metals alone.

As used herein, an “ordered inter metallic” also refers to a periodic structure of two (or more) materials in which the Pt and Pb elements occupy separate sub-lattices.

As used herein, “bulk target” refers to a macro scale quantity of the material intended for ablation in the current application

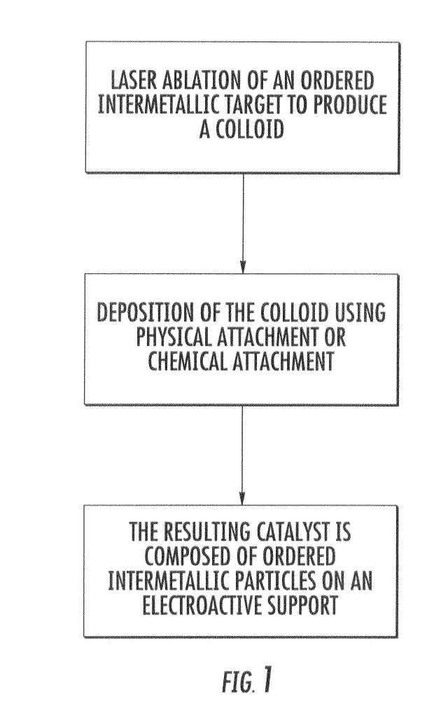

FIG. 1 schematically illustrates a method for fabrication of a heterogeneous catalyst in accordance with one embodiment. In at least one embodiment the method includes a combination of pulsed laser ablation in liquid (PLAL) and chemical or physical deposition of the particles onto carbon nanotube supports. In a preferred implementation laser ablation of an intermetallic target is carried out with an ultrashort pulsed laser system to produce stable colloids. The colloids are then deposited on an electroactive support, for example a substrate. The catalyst resulting from the above steps includes ordered intermetallic particles on the electroactive support.

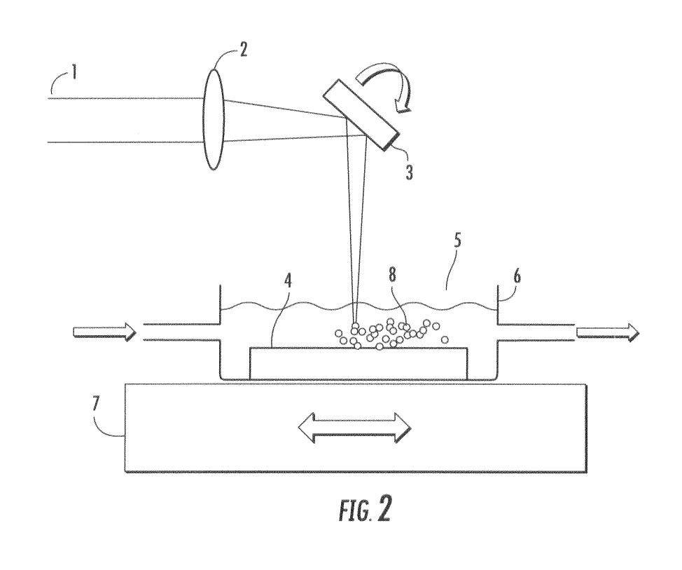

FIG. 2 schematically illustrates a laser-based system for producing nanoparticles in a liquid. This system may be the same or similar to that of U.S. patent application Ser. No. 12/320, 617 ('617), entitled “Production of nanoparticles with high repetition rate ultrashort pulsed laser ablation in liquids”, filed Jan. 30, 2009, which is hereby incorporated by reference in its entirety. The '617 application discloses, among other things, a physical method of producing nanoparticles, for example metal or metal-alloy nanoparticles, with ultrashort pulsed laser ablation in liquids, and teaches a method of producing stable nanoparticle colloids.

FIG. 2 of the present application schematically illustrates a portion of an exemplary laser-based system for producing nanoparticles in a liquid. Laser beam 1 is received from an ultrashort pulse source (not shown), focused by lens 2, and guided by a mechanism for rapid movement of a beam, for example a vibration minor 3, to a target 4. The target is submerged several millimeters below the surface of a liquid 5 that is contained in a container 6, and is preferably submerged less than 1 cm. The container 6 may be placed on a motion stage 7, for example a translation stage. Liquid flow can be introduced through the container so that the nanoparticles 8 can be carried away and collected elsewhere. The flow of liquid also cools the laser focal volume. The liquid is preferably de-ionized water having resistivity preferably greater than 1 M ohm/cm. In some embodiments the liquid may be distilled water, or another suitable liquid. A controller (not shown) is operatively coupled to the pulsed source, motion system, and/or circulation system. The controller coordinates beam delivery, liquid flow, and motion. The controller may also be coupled to a system computer, user interface, telecommunication equipment, and/or other standard devices, and configured so as to be programmed from a remote location.

Various embodiments of the present invention may utilize a near IR ultrashort laser, for example a D10K fiber laser system operating at about 1 μm wavelength and sub-picosecond pulse widths, available from IMRA America Inc. In some preferred implementations, short wavelength pulses, for example visible or UV wavelengths, may be utilized, and may be generated by frequency converting the output of a near IR laser to produce frequency converted pulses, with pulse widths in the fs-ps range. The wavelength may be selected based on the transmissibility of the liquid, for example. For example, frequency converted wavelengths may be less than about 600 nm, and/or 300 nm.

In certain embodiments, the PLAL method includes the following: submerging a target of the ordered intermetallic in water; ablating the target with pulses in a range from about 10 fs to 1 ps, irradiating the target with a fluence in the range from about 0.01 J cm⁻² to about 0.6 J cm⁻², with a wavelength shorter than 1100 nm, for example in the range from about 150 nm to 1100 nm. Ordered intermetallics are distinguished from alloys or metals in that they exhibit superlattice long range crystal ordering. The PtPb crystal is hexagonal close packed, which is essentially two FCC crystal lattices—one of Pt and one of Pb—which are interpenetrating. Nanosecond laser ablation in liquid commonly melts the target and/or the nanoparticles. If the PtPb nanoparticles are melted, they will phase segregate into Pt and PbO. The key to successful production of intermetallic particles is to use ultra-fast pulses coupled with carefully chosen fluences and wavelengths. The intermetallic is characterized by the Pt—Pt spacing on the surface of the intermetallic, the Pt—Pt spacing in PtPb is 3.0 A, while the Pt—Pt spacing in elemental Pt is 2.23 A.

In at least one embodiment, a short pulse duration is preferable because a pulse duration shorter than the thermal relaxation time prevents heating of the target or the nanoparticles in suspension, thus the pulse duration is below about 50 ps, or more preferably below about 1 ps. As recognized above, such limited heating is a factor to consider when producing PtPb particles because PtPb will oxidize into Pt and PbO at temperatures exceeding 500C. Excessive fluences also heat the sample or the nanoparticles and therefore sufficiently low fluence is utilized, for example below about 0.6 J cm⁻², or more preferably below 0.3 J cm ². Furthermore, the fluence may be above 0.003 J cm⁻² or more preferably above 0.01 J cm⁻². Short wavelengths are also preferred in various arrangements to limit the optical penetration depth of the light into the sample, which ablates a smaller area and reduces the polydispersity of particles formed.

By way of example, the following exemplary procedure was used to produce particles. In this section, all chemicals were used as received from commercial sources. PtPb nanoparticles were prepared by laser ablation of a PtPb target (Plasmaterials, 99.99% purity) in ethanol (Sigma-Aldrich, HPLC/Spectrophotometric grade, 200 proof) or water (10 MS2 cm⁻¹). A fiber laser system was used to produce the particles (D-10K system made by IMRA America Inc.). The laser output was attenuated to 1.7 W and a repetition rate of 500 kHz (2 μs pulse time separation) was used, yielding pulse energies of 3.4 μJ. A commercially available Scanlab hurrySCAN II system was used to scan the beam across the PtPb target surface. When the beam was focused on the target surface with a scan lens, nanoparticles were produced at a rate of 8 mg/min. The fluence with this scan lens arrangement and laser conditions was estimated to be 0.184±0.05 J cm⁻². The error in the fluence is given because as the thickness of the target changes during ablation, the focus at the target surface changes.

FIG. 3 exhibits different sizes of particles which were formed using femtosecond PLAL. Table 1 shows the particle compositions of particles 301-a, 301-b, and 301-c as determined by energy dispersive x-ray analysis.

TABLE 1

| EDS Position | Pt % | Pb % |
|---|---|---|
| 1 | 50 | 50 |
| 2 | 49 | 51 |
| 3 | 56 | 43 |

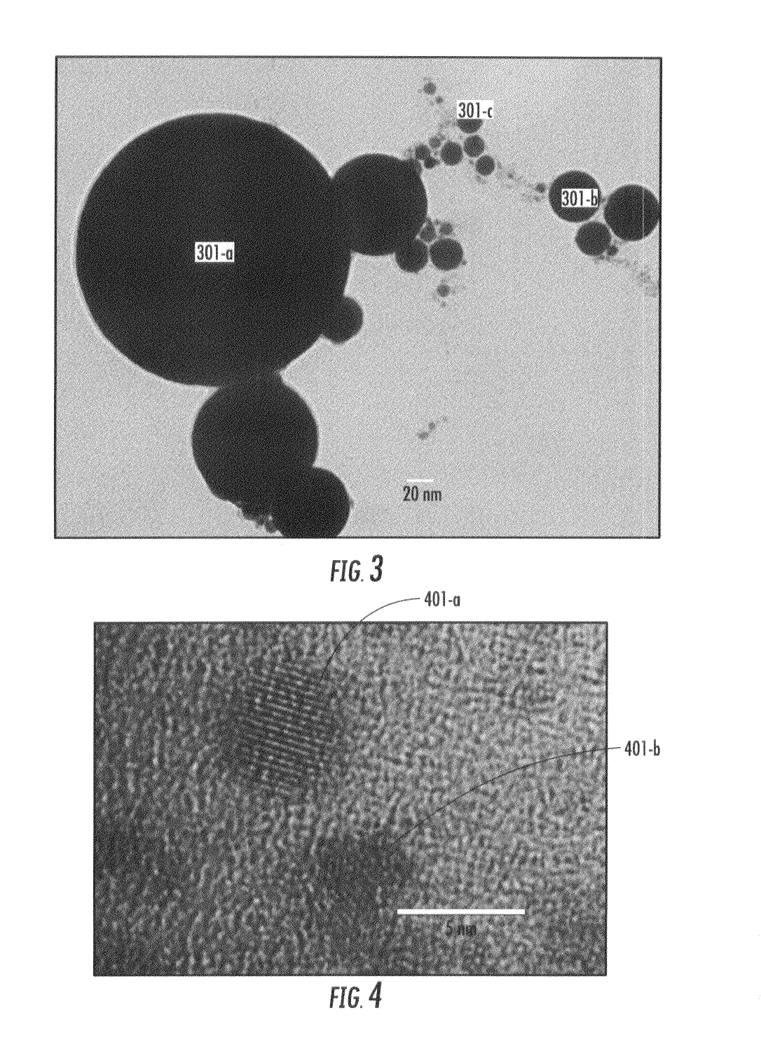

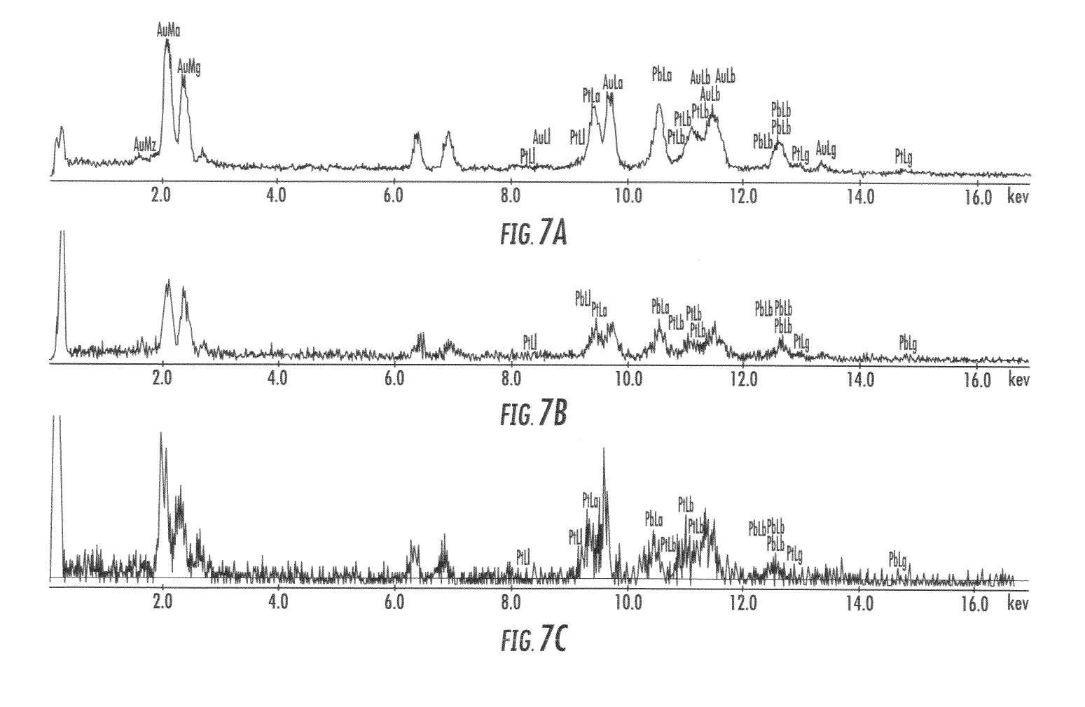

Compositions of the particles shown in FIG. 3 were determined by energy-dispersive x-ray spectroscopy (EDS) of the PtPb particles and fitting the resulting peaks with the Mott and Massey model. The corresponding spectra are shown in FIGS. 7A-7C. The particles in FIG. 3 were confirmed to have roughly a 50:50 ratio of Pt:Pb. The smallest particles are slightly Pt rich, which is expected because the outermost layer of Pb is known to be unstable.⁵¹ FIG. 4 is a high resolution transmission micrograph showing particles 401-a, 401-b formed by this method, with the above measurements carried out for particle 401-a, which was about 5 nm in size.

EDS is limited in accuracy (i.e.: it is only semiquantitative for particles this small). However, the d spacing can be used to confirm that particles are in fact PtPb. FIG. 4 shows a high resolution TEM micrograph of a 5 nm PtPb particle which has both Pt and Pb present as determined by EDS. The d spacing in this particle is ˜3.0 A, which corresponds well with the <101> plane of PtPb. The largest d spacing in elemental Pt is 2.26 A. This confirms that the particle is single crystal PtPb.

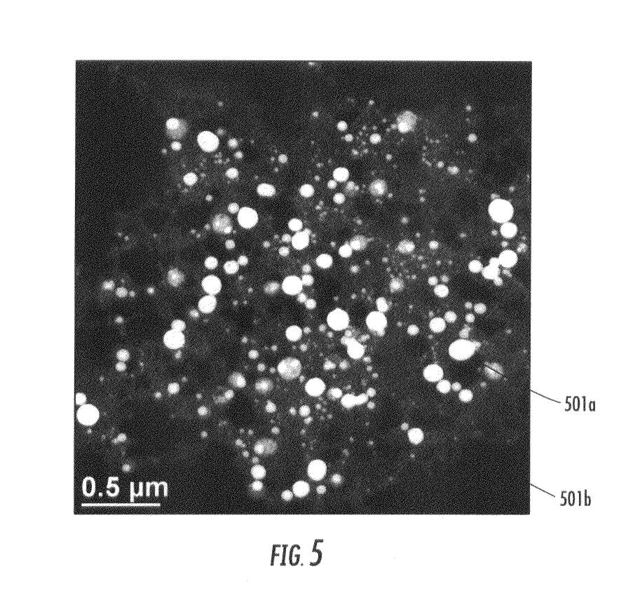

The results with femtosecond laser PLAL are contrasted to particles produced with nanosecond PLAL. The results for nanosecond PLAL are shown in FIG. 5. Table 2 shows the particle compositions of particles 501-a and 501-b as determined by energy dispersive x-ray analysis.

TABLE 2

| EDS Position | Pt % | Pb % |
|---|---|---|
| 1 | 96 | 4 |
| 2 | 0 | 100 |

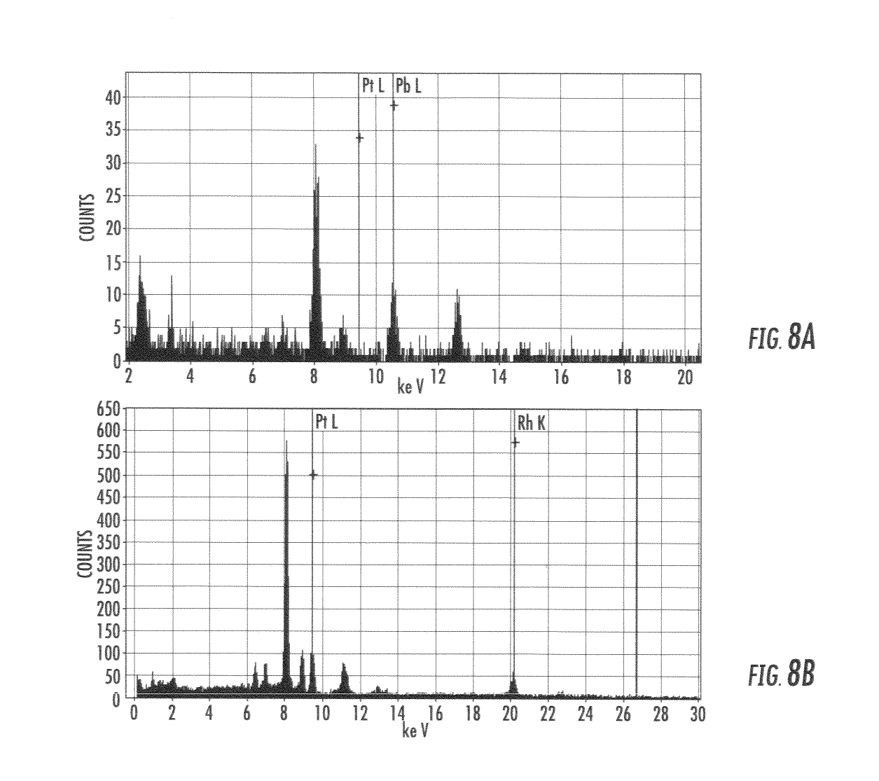

Compositions of the particles shown in FIG. 5 were determined by energy-dispersive x-ray spectroscopy (EDS) of the PtPb particles and fitting the resulting peaks with the Mott and Massey model. The corresponding spectra are shown in FIGS. 8A-8B. The particles in FIG. 5 are seen to be nearly or completely elemental; i.e., the intermetallic nature of the particles has been lost.

With PLAL, for example as described above, ordered intermetallic nanoparticles in a polar solvent are fabricated. Referring back to FIG. 1, after PLAL is completed the particles are then deposited on a substrate, more particularly an electroactive support. The electroactive support includes material which is electrically conductive, with a sufficiently high surface area, or high aspect ratio, for example a surface area of at least about 10 m² g⁻¹ and more preferably at least about 80 m² g⁻¹. By way of example, such a surface area may be measured by “BET theory”, a well-established technique for measurement of a specific surface area of a sample material. As a result of the deposition, a catalyst is formed, and includes ordered intermetallic nanoparticles deposited on the electroactive support. In at least one embodiment the catalyst includes an electroactive support, and the catalyst particles are supported thereon. The particles may have a composition represented by equation PtₓPb_{y} wherein x and y are both about 50% by number of atoms, with a nominal tolerance of +/−5%.

The substrate on which the nanoparticles are deposited can be electrically conductive or semi-conductive and becomes the electroactive support for a catalyst. As such, the catalyst is suitable for applications with electrochemical devices. The polarity of the deposition electrode can be either positive or negative depending on the charge of the colloid. The substrate and electroactive support may be in the form of, but is not limited to: (1) vertically aligned carbon nanotubes; (2) activated carbon in all its forms including Vulcan XR-72; or (3) mesoporous carbon. The counter electrode is typically made of either a conductive metal or a conductive alloy, including but not limited to, stainless steel, molybdenum, nickel, titanium, platinum, gold, or a metal-coated glass sheet.

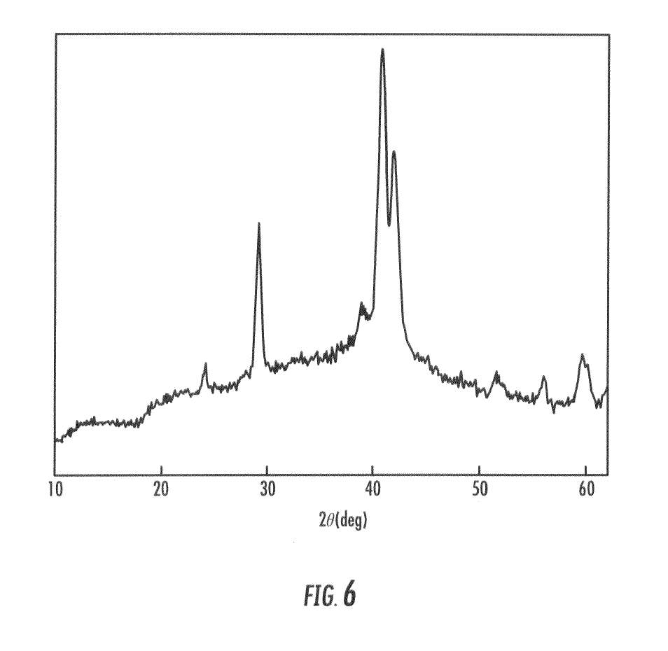

Powder X-ray diffraction of the PtPb nanoparticles as deposited on silicon is shown in FIG. 6. The peak positions match well with the reported PtPb crystal structure in the ICSD database (P6₃/mmc space group, ICSD PDF file no. 06-0374). From this we can conclude that the particles deposited on the surface are a thin film of PtPb.

A colloidal suspension of ordered intermetallic nanoparticles prepared by laser ablation in liquid are stabilized in solution because they are charged. This charge is a result of photons ionizing the material during the ablation process. This is an advantage for catalysts because additives and surfactants are not competing with desired reactant for surface space. The surface charge also makes the particles stable within the colloidal suspension, this is exemplified by measuring the zeta-potential which is on the order of −50 eV. In addition, the particles can be prepared directly in water or other suitable polar solvents without contamination with other elements. The resulting colloidal suspension of PtPb nanoparticles obtained with PLAL was stable for at least several minutes, but more often for more than one month. The stability is determined by the absence of aggregation during an extended time period after production and may be verified by UV-Vis measurements. In addition, unlike previously mentioned methods for preparing PtPb by chemical methods, contamination with boron or sulfur is reduced from concentrations on the order of 1-2 millimole (mM) to less than 1 ppm. Furthermore, particle sizes of 25 nm on average can be obtained using this method and with fine adjustment to optimize laser conditions, particles sizes of 10 nm on average can be obtained.

Deposition onto Carbon Nanotubes:

The nanoparticles can also be applied to carbon nanotubes by creating a mixture of colloidal nanoparticles, nafion, and suspended carbon nanotubes. In this process, nafion coats the carbon nanotubes while the ordered intermetallic particles stick to the surface of the coated carbon nanotubes. The carbon nanotubes can then be spin cast, drop cast, or electrophoretically deposited onto a conductive support, during or following which the water is removed. A similar process has been previously used for depositing Pt particles onto carbon nanotubes.⁵² However, in accordance with an embodiment of the present invention a stable suspension of PtPb produced from PLAL is used rather than the suspension of Pt produced from chemical methods in the prior art.

Deposition of PtPb onto an electroactive support can also be accomplished using the following method. Prior to use, glassy carbon (GC) electrodes were polished with 0.05 micron alumina powder (CH Instruments) and ultrasonicated in Millipore water (10 MΩ·cm⁻¹, Millipore RiOs-DI 3) for 10 minutes and allowed to dry in air. Suspensions of PtPb nanoparticles in water were diluted with isopropyl alcohol (Alfa Asear, 99.5%) at a ratio of 4:1, and 20 μL of 5% w/w Nafion solution in alcohols and water (Aldrich, EW: 1100) was added to the mixture of nanoparticles, isopropanol, and water. The nanoparticle suspension was coated onto the clean 3 mm glassy carbon electrode described above by drop casting and allowing the solvents to evaporate in air.

In fuel cell applications the PtPb composition can provide certain benefits. For one, formic acid or methanol can be used as a fuel rather than hydrogen, because the PtPb intermetallic doesn't poison from CO adsorption. In addition, a higher mass activity means that a lower Pt loading is required, for example PtRu loading on the catalyst surface in the range of about 0.5 to 1 mg cm⁻¹ is suitable. For a device generating a similar power density, a PtPb loading of about 0.1 to 0.3 mg cm-1 is suitable.

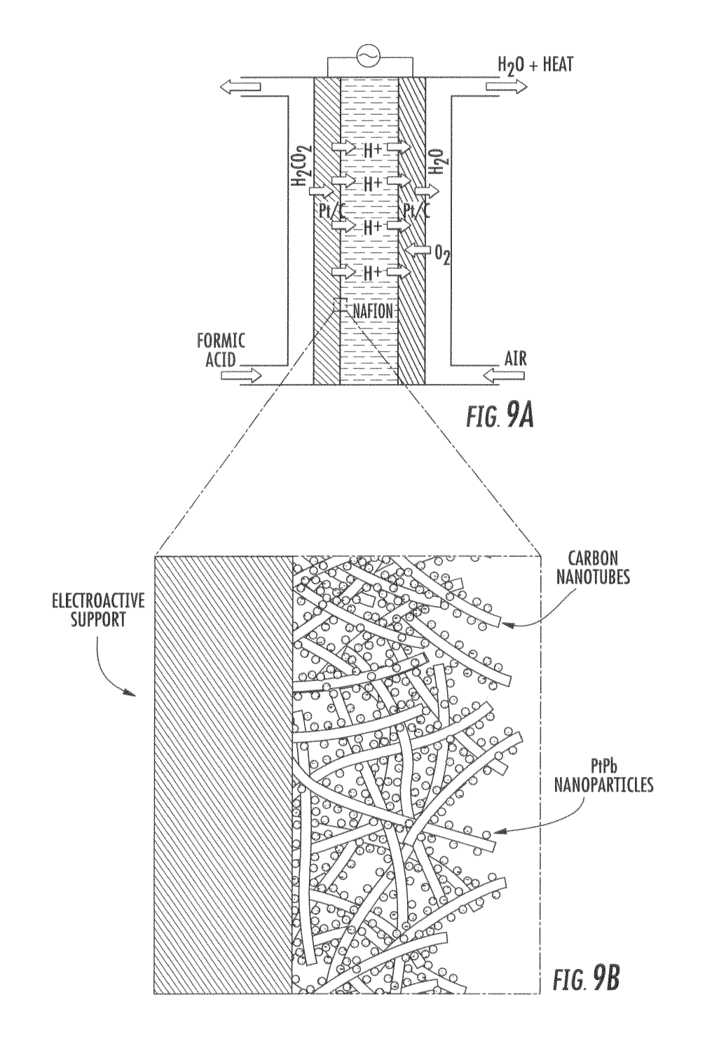

FIGS. 9a and 9b schematically illustrate a fuel cell (FIG. 9A) that includes a catalyst according to an embodiment of the present invention, and an expanded schematic view (FIG. 9B) of the catalyst wherein nanoparticles are deposited on nanotubes which serve as a portion of the electroactive support. As discussed above, PtPb nanoparticles are deposited onto carbon nanotubes, and the nanoparticles are preferably less than about 100 nm in average diametral size, and more preferably less than about 10 nm. The spatial extent of the carbon nanotubes along a direction normal to their support may be in the range from a fraction of one micron to tens of microns. As shown in FIG. 9A formic acid is used as a fuel. As discussed above, a fuel cell with improved properties is obtainable.

Thus, the invention has been described by way of various examples and embodiments. For example:

At least one embodiment includes a method for fabricating a catalyst. The catalyst includes a colloidal suspension of nanoparticles, the nanoparticles including intermetallics of two or more metals exhibiting long range superlattice crystal ordering. The method includes providing a bulk target of the intermetallics of the two or more metals exhibiting long range superlattice crystal ordering. The method further includes submerging the target in a solvent. A pulsed laser is used to ablate bulk target material and produce nanoparticles of the intermetallics of two or more metals exhibiting long range superlattice crystal ordering, in the solvent, to produce a colloidal suspension of the nanoparticles.

Ordered intermetallic nanoparticles may include PtPb, PtBi, PtBi2, PtSn, Pt3Sn, PdMo, PtNi, or PdGa.

Intermetallic nanoparticles may be characterized by having a Pt—Pt spacing of atoms on the surface greater than about 3.5 angstroms.

Intermetallic nanoparticles may be characterized by having a Pt—Pt spacing of atoms on the surface greater than about 2.7 angstroms.

A nanoparticle colloid may be stable for more than about 1 month.

A solvent may be a polar solvent, and may include ethanol, water, and/or an ethanol/acetone mixture.

Ablation may include irradiating a target with pulses shorter than about 1 ps.

Ablation may include irradiating the target with pulses shorter than about 50 ps.

A catalyst may include nanoparticles which are about 25 nm in average size.

A catalyst may include nanoparticles which are about 10 nm in average size.

A pulsed laser may provide laser fluence greater than about 10 mJ cm⁻².

A pulsed laser may provide laser fluence greater than about 3 mJ cm⁻².

A pulsed laser may provide laser fluence less than about 0.6 J cm⁻².

A pulsed laser may provide laser fluence less than about 0.3 J cm⁻².

At least one embodiment includes catalyst including a colloidal suspension of nanoparticles. The nanoparticles include intermetallics of two or more metals exhibiting long range superlattice crystal ordering. The colloidal suspension is prepared by a method that includes: providing a bulk target of the intermetallics of two or more metals exhibiting long range superlattice crystal ordering; submerging the target in a solvent; and using a pulsed laser to ablate bulk target material and produce nanoparticles of the intermetallics of two or more metals exhibiting long range superlattice crystal ordering, in the solvent.

A solvent may include water, ethanol, or acetone.

A catalyst may include nanoparticles which are about 25 nm in average size.

The catalyst may include nanoparticles which are about 10 nm in average size.

A concentration of elements in a colloidal suspension, other than those which include the solvent or the intermetallic compound, may be less than about 100 ppm.

A concentration of elements in a colloidal suspension, other than those which include the solvent or the intermetallic compound, may be less than about 1 ppm.

At least one embodiment includes a method for fabricating a platinum-lead intermetallic catalyst. The method includes providing a bulk target of ordered intermetallic PtPb, in which the Pt and Pb elements occupy separate sub-lattices. The method includes submerging the target in a solvent. A pulsed laser is used to ablate bulk target material and produce PtPb intermetallic nanoparticles exhibiting long range superlattice crystal ordering, wherein the nanoparticles are colloidally suspended in the solvent. The method includes depositing the colloidal suspension onto an electroactive, high aspect ratio support.

For purposes of summarizing the present invention, certain aspects, advantages and novel features of the present invention are described herein. It is to be understood, however, that not necessarily all such advantages may be achieved in accordance with any particular embodiment Thus, the present invention may be embodied or carried out in a manner that achieves one or more advantages without necessarily achieving other advantages as may be taught or suggested herein.

It is to be understood that the embodiments are not mutually exclusive, and elements described in connection with one embodiment may be combined with, or eliminated from, other embodiments in suitable ways to accomplish desired design objectives.

As used herein, the term “or” is intended to mean an inclusive “or” rather than an exclusive “or”, unless specified. In addition, the articles “a” and “an” as used in this application and the appended claims are to be construed to mean “one or more” or “at least one” unless specified otherwise.

While only certain embodiments have been specifically described herein, it will be apparent that numerous modifications may be made thereto without departing from the spirit and scope of the invention. For example, various embodiments and features therein are generally not to be construed as mutually exclusive; such embodiments and features may be combined and/or modified by a person skilled in the art. Further, acronyms are used merely to enhance the readability of the specification and claims. It should be noted that these acronyms are not intended to lessen the generality of the terms used and they should not be construed to restrict the scope of the claims to the embodiments described therein.

### REFERENCES

1. Casado-Rivera, E.; Volpe, D. J.; Alden, L.; Lind, C.; Downie, C.; Vázquez-Alvarez, T.; Angelo, A. C. D.; DiSalvo, F. J.; Abruña, H. D., J. Am. Chem. Soc. 2004, 126, 4043.
2. Zhang, J., PEM Fuel Cell Electrocatalysts and Catalyst Layers: Fundementals and Applications. Springer-Verlag: London, 2008.
3. Casado-Rivera, E.; Gál, Z.; Angelo, A. C. D.; Lind, C.; DiSalvo, F. J.; Abruña, H. D., Chem. Phys. Chem. 2003, 4, 193.
4. DiSalvo, F. J.; Abruña, H. D. Intermetallic Compounds for use as Catalysts and Catalytic Systems. 2004.
5. Vielstich, W.; Gasteiger, H. A.; Yokokawa, H., Handbook of Fuel Cells: Andvances in Electrocatalysis, Materials, Diagnostics and Durability. Wiley: Hoboken, 2009.
6. Liu, H.; Song, C.; Zhang, L.; Zhang, J.; Wang, H.; Wilkinson, D. P., Journal of Power Sources 2006, 155 (2), 95-110.
7. Abe, H.; Matsumoto, F.; Alden, L. R.; Warren, S.C.; Abruña, H. D.; DiSalvo, F. J., Journal of the American Chemical Society 2008, 130 (16), 5452-5458.
8. de-los-Santos-Álvarez, N.; Alden, L. R.; Rus, E.; Wang, H.; DiSalvo, F. J.; Abruña, H. D., Journal of Electroanalytical Chemistry 2009, 626 (1-2), 14-22.
9. Leonard, B. M.; Zhou, Q.; Wu, D.; DiSalvo, F. J., Chemistry of Materials 2011, 23 (5), 1136-1146.
10. Roychowdhury, C.; Matsumoto, F.; Mutolo, P. F.; Abruña, H. D.; DiSalvo, F. J., Chem. Mater. 2005, 17, 5871.
11. Blasini, D. R.; Rochefort, D.; Fachini, E.; Alden, L. R.; DiSalvo, F. J.; Cabrera, C. R.; Abruña, H. D., Surface Science 2006, 600 (13), 2670-2680.
12. Roychowdhury, C.; Matsumoto, F.; Zeldovich, V. B.; Warren, S. C.; Mutolo, P. F.; Ballesteros, M.; Wiesner, U.; Abruña, H. D.; DiSalvo, F. J., Chemistry of Materials 2006, 18 (14), 3365-3372.
13. Jeyabharathi, C.; Mathiyarasu, J.; Phani, K., Journal of Applied Electrochemistry 2009, 39 (1), 45-53.
14. Yu, X.; Pickup, P. G., Electrochimica Acta 2011, 56 (11), 4037-4043.
15. Ghosh, T.; Zhou, Q.; Gregoire, J. M.; van Dover, R. B.; DiSalvo, F. J., The Journal of Physical Chemistry C 2010, 114 (29), 12545-12553.
16. Miura, A.; Wang, H.; Leonard, B. M.; Abruña, H. c. D.; DiSalvo, F. J., Chemistry of Materials 2009, 21 (13), 2661-2667.
17. Wang, J.; Thomas, D. F.; Chen, A., Analytical Chemistry 2008, 80 (4), 997-1004.
18. Kameoka, S.; Tsai, A. P., Catalysis Today 2008, 132 (1-4), 88-92.
19. Liu, F.; Lee, J. Y.; Zhou, W., The Journal of Physical Chemistry B 2004, 108 (46), 17959-17963.
20. Alden, L. R.; Roychowdhury, C.; Matsumoto, F.; Han, D. K.; Zeldovich, V. B.; Abruña, H. D.; DiSalvo, F. J., Langmuir 2006, 22 (25), 10465-10471.
21. Bauer, J. C.; Chen, X.; Liu, Q.; Phan, T.-H.; Schaak, R. E., Journal of Materials Chemistry 2008, 18 (3), 275-282.
22. Liu, Z.; Guo, B.; Tay, S. W.; Hong, L.; Zhang, X., Journal of Power Sources 2008, 184 (1), 16-22.
23. Matsumoto, F.; Roychowdhury, C.; DiSalvo, F. J.; Abruña, H. D., Journal of the Electrochemical Society 2008, 155 (2), B148.
24. Najjar, R.; Stubenrauch, C., Journal of Colloid and Interface Science 2009, 331 (1), 214-220.
25. Alden, L. R.; Han, D. K.; Matsumoto, F.; Abruña, H. D.; DiSalvo, F. J., Chemistry of Materials 2006, 18 (23), 5591-5596.
26. Zhitomirsky, I., Journal of Materials Science Letters 1998, 17 (24), 2101-2104.
27. Verwey, E. J. W.; Overbeek, J. T. G., Theory of Stability of Lyophobic Colloid. Elsevier: Amsterdam, 1948.
28. A., S. G., Lasers in Chemistry 2. Wiley VCH Verlag GmbH&Co: Wienheim, 2008.
29. Tarasenko, N. V.; Butsen, A. V., Quantum Electronics 2010, 40 (11), 986.
30. Nolte, S.; Momma, C.; Jacobs, H.; Tünnermann, A.; Chichkov, B. N.; Wellegehausen, B.; Welling, H., J. Opt. Soc. Am. B 1997, 14 (10), 2716-2722.
31. Preuss, S.; Demchuk, A.; Stuke, M., Applied Physics A: Materials Science & Processing 1995, 61 (1), 33-37.
32. Pronko, P. P.; Dutta, S. K.; Du, D.; Singh, R. K., Journal of Applied Physics 1995, 78 (10), 6233-6240.
33. Pronko, P. P.; Dutta, S. K.; Squier, J.; Rudd, J. V.; Du, D.; Mourou, G., Optics Communications 1995, 114 (1-2), 106-110.
34. Morales, A. M.; Lieber, C. M., Science 1998, 279 (5348), 208-211.
35. Tsuji, T.; Kakita, T.; Hamagami, T.; Kawamura, T.; Yamaki, J.; Tsuji, M., Chemistry Letters 2004, 33 (9), 1136-1137.
36. Patil, P. P.; Phase, D. M.; Kulkarni, S. A.; Ghaisas, S. V.; Kulkarni, S. K.; Kanetkar, S. M.; Ogale, S. B.; Bhide, V. G., Physical Review Letters 1987, 58 (3), 238-241.
37. Bajaj, G.; Soni, R., Applied Physics A: Materials Science &amp; Processing 2009, 97 (2), 481-487.
38. Riabinina, D.; Irissou, E.; Le Drogoff, B.; Chaker, M.; Guay, D., Journal of Applied Physics 2010, 108 (3), 034322-6.
39. \check{S}mejkal, P.; Pfleger, J.; Vl\check{c}ková, B., Applied Physics A: Materials Science &amp; Processing 2010, 101 (1), 37-40.
40. Zhang, J.; Lan, C. Q., Materials Letters 2008, 62 (10-11), 1521-1524.
41. Boutinguiza, M.; Pou, J.; Lusqui\ddot{n}os, F.; Comesa\ddot{n}a, R.; Riveiro, A., Physics Procedia 2011, 12 (Part 2), 54-59.
42. Boyer, P.; Ménard, D.; Meunier, M., The Journal of Physical Chemistry C 2010, 114 (32), 13497-13500.
43. Jurij, J.; et al., Nanotechnology 2011, 22 (14), 145601.
44. Tan, D.; Lin, G.; Liu, Y.; Teng, Y.; Zhuang, Y.; Zhu, B.; Zhao, Q.; Qiu, J., Journal of Nanoparticle Research 2011, 13 (3), 1183-1190.
45. Yang, S.; Cai, W.; Zhang, H.; Xu, X.; Zeng, H., The Journal of Physical Chemistry C 2009, 113 (44), 19091-19095.
46. Matsumoto, H.; Higuchi, K.; Kyushin, S.; Goto, M., Angewandte Chemie International Edition in English 1992, 31 (10), 1354-1356.
47. Kanemitsu, Y.; Suzuki, K.; Kondo, M.; Kyushin, S.; Matsumoto, H., Physical Review B 1995, 51 (16), 10666-10670.
48. Wang; Huang; Ren, Langmuir 2004, 21 (2), 751-754.
49. Itina, T. E., The Journal of Physical Chemistry C 2010, 115 (12), 5044-5048.
50. Bogaerts, A.; Chen, Z.; Gijbels, R.; Vertes, A., Spectrochimica Acta Part B: Atomic Spectroscopy 2003, 58 (11), 1867-1893.
51. Uhm, S.; Chung, S. T.; Lee, J., Electrochemistry Communications 2007, 9 (8), 2027-2031.
52. Kongkanand, A.; Kuwabata, S.; Girishkumar, G.; Kamat, P., Langmuir 2006, 22 (5), 2392-2396.

What we claim is:

1. A method for fabricating a catalyst comprising a colloidal suspension of nanoparticles, said nanoparticles comprising intermetallics of two or more metals exhibiting long range superlattice crystal ordering, the method comprising the steps of:
providing a bulk target of said intermetallics of two or more metals exhibiting long range superlattice crystal ordering;
submerging said target in a solvent; and
using a pulsed laser to ablate bulk target material and produce nanoparticles of said intermetallics of two or more metals exhibiting long range superlattice crystal ordering, in said solvent, to produce a colloidal suspension of said nanoparticles.

2. The method of claim 1, wherein said ordered intermetallic nanoparticles comprise PtPb, PtBi, PtBi2, PtSn, Pt3Sn, PdMo, PtNi, or PdGa.

3. The method according to claim 1, wherein said intermetallic nanoparticles are characterizable by Pt—Pt spacing of atoms on the surface greater than about 3.5 angstroms.

4. The method according to claim 1, wherein said intermetallic nanoparticles are characterizable by a Pt—Pt spacing of atoms on the surface greater than about 2.7 angstroms.

5. The method of claim 1, wherein the nanoparticle colloid is stable for more than about 1 month.

6. The method of claim 1, wherein said solvent is a polar solvent and comprises ethanol, water, and/or an ethanol/acetone mixture.

7. The method of claim 1, wherein said ablation comprises irradiating the target with pulses shorter than about 1 ps.

8. The method of claim 1, wherein said ablation comprises irradiating the target with pulses shorter than about 50 ps.

9. The catalyst of claim 1, wherein catalyst comprises nanoparticles which are about 25 nm on average.

10. The catalyst of claim 1, wherein catalyst comprises nanoparticles which are about 10 nm on average.

11. The method of claim 1, wherein the pulsed laser provides a laser fluence greater than about 10 mJ cm⁻².

12. The method of claim 1, wherein the pulsed laser provides a laser fluence greater than about 3 mJ cm⁻².

13. The method of claim 1, wherein the pulsed laser provides a laser fluence less than about 0.6 J cm⁻².

14. The method of claim 1, wherein the pulsed laser provides a laser fluence less than about 0.3 J cm⁻².

15. A catalyst comprising a colloidal suspension of nanoparticles, said nanoparticles comprising intermetallics of two or more metals exhibiting long range superlattice crystal ordering, the colloidal suspension prepared by the method of:
providing a bulk target of said intermetallics of two or more metals exhibiting long range superlattice crystal ordering;
submerging said target in a solvent; and
using a pulsed laser to ablate bulk target material and produce nanoparticles of said intermetallics of two or more metals exhibiting long range superlattice crystal ordering, in said solvent.

16. The catalyst of claim 15, wherein the solvent comprises water, ethanol, or acetone.

17. The catalyst of claim 15, wherein said catalyst comprises nanoparticles which are about 25 nm on average.

18. The catalyst of claim 15, wherein said catalyst comprises nanoparticles which are about 10 nm on average.

19. The catalyst of claim 15, wherein the concentration of elements in said colloidal suspension other than those which comprise the solvent or the intermetallic compound are less than about 100 ppm.

20. The catalyst of claim 15, wherein the concentration of elements in said colloidal suspension other than those which comprise the solvent or the intermetallic compound are less than about 1 ppm.

21. A method for fabricating a platinum-lead intermetallic catalyst, comprising;
providing a bulk target of ordered intermetallic PtPb, in which the Pt and Pb elements occupy separate sub-lattices;
submerging said target in a solvent; and
using a pulsed laser to ablate bulk target material and produce PtPb intermetallic nanoparticles exhibiting long range superlattice crystal ordering; said nanoparticles being colloidally suspended in said solvent; and
depositing said colloidal suspension onto an electroactive, high aspect ratio support.
